(19) United States
(12) Patent Application Publication
(10) Pub. No.: US 2006/0111978 A1
(43) Pub. Date: May 25, 2006

(54) Method, system and computer program for providing a loyalty engine enabling dynamic administration of loyalty programs

(75) Inventors: Terrance Patrick Tietzen, Edmonton (CA); Mark Marcel Archinuk, Edmonton (CA); Tamara Mary Haskins, Edmonton (CA)

Correspondence Address: MILLER THOMPSON, LLP, Scotia Plaza, 40 King Street West, Suite 5800, TORONTO, ON, M5H 3S1, CA

(73) Assignees: Terrance Patrick Tietzen; Mark Marcel Archinuk; Tamara Mary Haskins

(21) Appl. No.: 11/283,856

(22) Filed: Nov. 22, 2005

(30) Foreign Application Priority Data
Nov. 23, 2004 (CA) 2,488,272

(51) Int. Cl. G06Q 30/00

(52) U.S. Cl. 705/14

(57) ABSTRACT

A method, computer system, and computer program product for encouraging customer loyalty is provided. The method includes the steps of: (1) one or more partners defining a loyalty program, the loyalty program defining loyalty rewards, cross-promotional partner rewards and prizes associated with one or more activities; (2) registering one or more members with the loyalty program, whereby their registration includes the provision of registered form of payment data for one or more registered form of payment types of each of the one or more participants; (3) collecting financial data corresponding to transactions of the one or more members associated with the one or more partners, and providing said financial data to a loyalty engine; (4) providing access to the loyalty engine to the one or more members, the loyalty engine permitting the one or more partners: (a) to define the rules defining the loyalty program, including special partner rewards including cross-promotional rewards between partners, loyalty rewards, and chances to win prizes; (b) to monitor the effectiveness of the loyalty program; and (c) to modify the loyalty program to enhance its effectiveness. The computer system includes the loyalty engine of the invention. The computer program product consists of a server application that includes the loyalty engine of the invention. Partners access a number of software utilities linked to the loyalty engine to assess the effectiveness of the loyalty programs and customize the attributes of the loyalty programs to improve effectiveness. Members access the loyalty engine real time and use loyalty reward actions for prize opportunities.

### FIELD OF THE INVENTION

This invention relates to creation and administration of loyalty reward programs. This invention relates more particularly to Internet solutions for creating and administering loyalty reward programs.

### BACKGROUND OF THE INVENTION

Numerous customer loyalty programs are known.

Customer loyalty systems also play an increasingly important role. The use of the Internet in the area of administering loyalty programs is also known.

For example, U.S. application Ser. No. 10/068,469 (Published, Aug. 29, 2002), assigned to International Business Machines Corporation relates to a “Method, Computer System, and Computer Program Product for Processing Customer Loyalty Data”. The invention provides for front-end devices, such as front-end input terminals for inputting of transaction data, such as data specifying goods or services to be purchased by a customer. The front-end devices can be distributed in the field, for example in retail shops, super market and point-of-sale terminals. The front-end devices have a spreadsheet engine which comprises the data processing kernel of a spreadsheet program such as Lotus 1-2-3 or Microsoft Excel. The front-end device advantageously can be integrated with a point-of-sale terminal for a processing of a customer's checkout and payment. Furthermore the invention is advantageous in that it allows the updating of loyalty rules without a need to separately reprogram each of the front-end devices in the field. Changing of loyalty rules in the database of the back-end computer will cause updating of the loyalty rules of the front-end devices when synchronization occurs. Transaction data between the front-end and the back-end occurs via the Internet.

U.S. application Ser. No. 09/909,194 (Published Jan. 31, 2002) in the name of Michael A. Wilkman, relates to a “Universal Transaction Manager Agent, Systems and Methods”. This invention provides a transaction engine that enables a user to match and coordinate the use of credit accounts, debit accounts, loyalty (points) programs, affinity (points) programs, promotions, and currency exchanges to enhance the purchase transaction of consumers and businesses. The enhancements may include financial, promotional, or other benefits for various purchases of goods and services thereby enabling partners to target their incentives to consumers and businesses prior to or at the time of the purchase transactions.

There are a number of disadvantages to the prior art solutions.
Prior art solutions generally require a separate loyalty ID. Most customer loyalty programs require action from the user to associate the customer loyalty program with the consumer behaviour, for example, use of a special loyalty card, or provision of a loyalty card number. This complicates the deployment of the loyalty program, and also makes it less convenient for the customer to participate.
Many prior art solutions are based on specific incentives, and/or points, so it is more difficult for a participant to cumulate chances to win a big prize.
Rewards are generally not processed in real time, so a participant has to wait for up to a month to see the incentive earned.
Rewards are generally not redeemed at the partner's physical site, therefore there is a missed opportunity to further encourage customer loyalty by means of personal interaction.
Prior art and practice do not generally provide a solution that enables customization of loyalty programs on the fly based on effectiveness and incremental cost.

### SUMMARY OF THE INVENTION

One aspect of the present invention is a method of encouraging customer loyalty, including the steps of: (1) One or more merchants (e.g. partners) defining a loyalty program, the loyalty program defining loyalty rewards associated with one or more activities; (2) Registering one or more members with the loyalty program, whereby their registration includes the provision of registered form of payment data for one or more registered form of payments of each of the one or more members; (3) Collecting financial data corresponding to transactions of the one or more members associated with the one or more partners, and providing said financial data to a loyalty engine; (4) Providing access to the loyalty engine to the one or more partners, the loyalty engine permitting the one or more partners: (a) To define the rules defining the loyalty program, including accumulation of loyalty rewards, chances to win prizes, redemption of loyalty rewards from the partner and combined offers with other participating partners to cross promote products/services and provide rewards and/or discount offers to customer-selected benefit programs; (b) Monitoring the effectiveness of the loyalty program; and (c) Modifying the loyalty program to enhance its effectiveness.

Another aspect of the invention is a computer system that includes the described loyalty engine. Another aspect of the invention is a computer program product consisting of the loyalty engine.

In a particular aspect of the invention, the completion of a survey is linked to an opportunity to win prizes.

In yet another particular aspect of the invention, members make a reservation for special partner rewards through the loyalty engine, and rewards are collected from the partner by the member presenting the member reward number at a location of the applicable partner.

In a still other aspect of the present invention, a method, computer system, and computer program product is provided that enables a plurality of partners to co-operate to provide loyalty benefits jointly, by operation of the loyalty engine.

### BRIEF DESCRIPTION OF THE DRAWINGS

A detailed description of the preferred embodiment(s) is (are) provided herein below by way of example only and with reference to the following drawings, in which:

FIG. 1 is a system resource diagram illustrating the resources of the system of the present invention.

FIG. 2 is a program resource diagram illustrating the main components of the computer program of the present invention.

FIG. 3 is a flowchart illustrating the member/partner log-in/registration process, in one particular implementation of the present invention.

FIG. 4 is a flowchart illustrating the processes involved in operation of the member area, in one particular embodiment thereof.

FIG. 5 is a further flowchart illustrating the processes involved in operation of the member area, in one particular embodiment of adding a registered form of payment thereof.

FIG. 6 is a flowchart illustrating the processes involved in operation of the member rewards utility of the present invention.

FIG. 7 is flowchart illustrating the processes involved in operation of the Partners facility (ies) locator or locator utility of the present invention.

FIG. 8 is a flowchart illustrating the processes involved in operation of the member area, which illustrates the member rewards confirmation option (MRC#) in a particular aspect of the present invention.

FIG. 9 is a flowchart illustrating the processes involved in operation of the loyalty engine to notify the member by electronic means to provide the member reward confirmation, in accordance with a particular implementation of the present invention.

FIG. 10 is a flowchart illustrating the processes involved in operation of the loyalty engine to provide an alternate shopping list in lieu of the electronic notification process.

FIG. 11 is a flowchart illustrating the processes involved in operation of the loyalty engine whereby the member redeems the participating partners' reward(s) at the partners' location(s).

FIG. 12 is a flowchart illustrating the processes involved in a member completing a survey created in accordance with the invention, in one particular embodiment thereof.

FIG. 13 is a flowchart illustrating the processes involved in a member entered into applicable prize pools and the prize administration for winners, in a particular implementation of the present invention.

FIG. 14 is a flowchart illustrating the operation of the internal processes of the Partner/Member Relationship Management or the partner administration utility of the present invention, in a particular embodiment of the present invention.

FIG. 15 is a flowchart illustrating a particular aspect of the partner reward administration facility, namely the processes involved in creating and maintaining current partner rewards, in a particular embodiment of the present invention.

FIG. 16 is a flowchart illustrating a particular aspect of the partner reward administration facility, namely the processes involved in creating and maintaining next period partner rewards, in a particular embodiment of the present invention.

FIG. 17 is a flowchart illustrating a particular process for creating cross-promotional rewards in the partner administration facility, in a particular embodiment of the present invention.

FIG. 18 is a flowchart illustrating a particular process for administering partner prizes contributed to the applicable prize pool, in a particular embodiment of the present invention.

FIG. 19 is a flowchart illustrating a particular process for administering sponsor prizes contributed to the applicable prize pool, in a particular embodiment of the present invention.

FIG. 20 is a flowchart illustrating a particular process for partners to view the geographic location of participating members, in a particular embodiment of the present invention.

FIG. 21 is a flowchart illustrating a particular process for partners to view measured results and feedback of participating members, in a particular embodiment of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

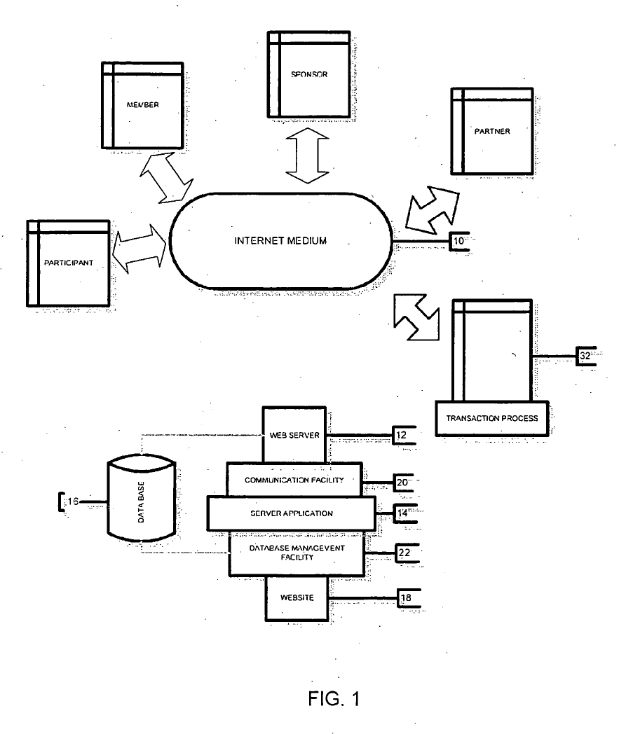

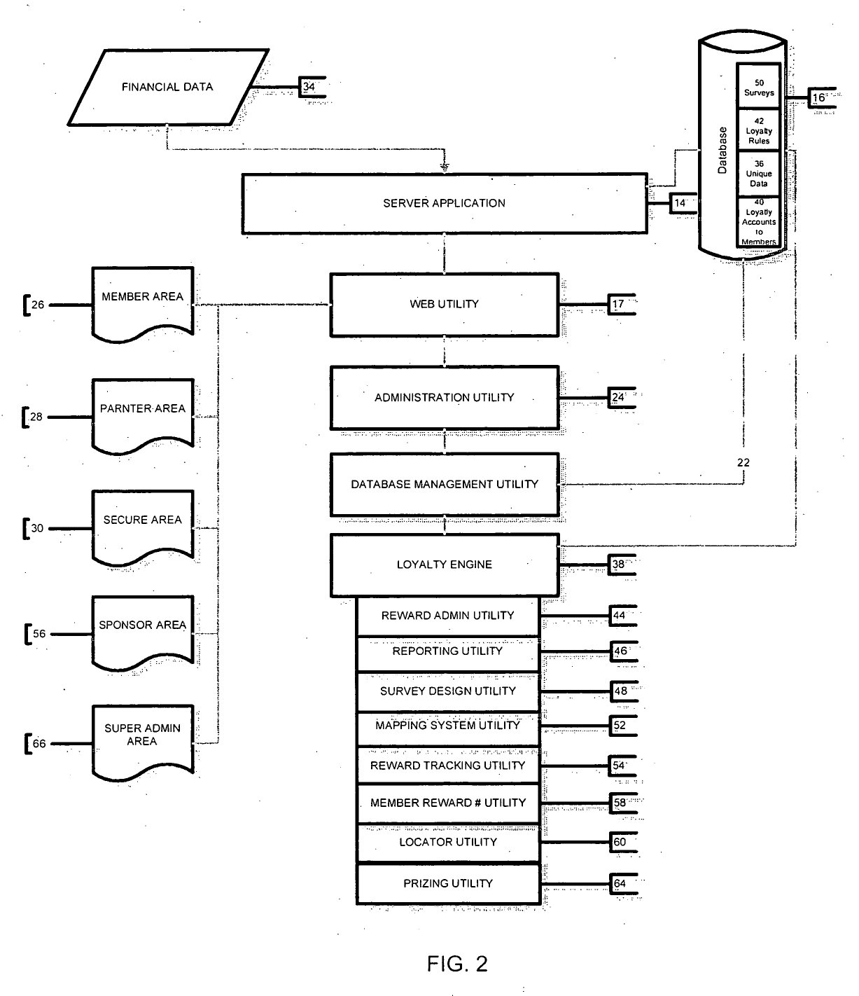

Referring to FIG. 1 and FIG. 2, there is illustrated a system resource diagram illustrating one aspect of the system of the present invention. By means of the Internet medium (10), a web server (12) is made accessible to a plurality of users (described below).

One aspect of the server computer (12) is that it includes a server application (14) which consists of the computer program of the present invention. The server computer (12) is linked to a known database (16).

In one particular implementation of the present invention, the server computer (12) consists of one or more servers including one or more web servers (e.g. an IBM™ HTTP Server or similar server), at least one application server (e.g. an IBM™ server running WEBSPHERE™ software or similar), and at least one database server (e.g. an IBM™ server running IBM™ DB2 database or similar). In addition, in a particular implementation of the present invention, the server computer (12) also includes a server dedicated to importing real time or batch financial data (as explained above).

One aspect of the server application (14) is that it includes a web utility (17) for publishing a web site (18) to the Internet Medium (10) in a manner that is known. The features of the web site (18) of the present invention are described below.

The web site (18) includes a member area (26) and a partner area (28), as illustrated in FIG. 2. Members are generally understood to be individual or corporate users who sign up with the web site (18) for joining one or more of the loyalty programs linked to the operator of the server computer (12). Partners include businesses that provide products and/or services (including rewards and prizes) directly to members.

The member area (26) consists of a series of web pages containing fields for obtaining sign-up information generally from members. The sign-up information includes the name, e-mail address, and primary shopping region of the particular member.

The member area (26) also includes a secure area (30), provided in a manner that is known. One aspect of the present invention is the collection of information from the participants regarding one or more of their registered form of payments. The registered form of payment information enables the operator of the server computer(s) (12) to track financial transactions of the member linked to partners of the web site (18), as particularized below.

The registered forms of payments include a wide variety of cards or other electronic or magnetic transaction devices, such as banking cards or credit cards. In a preferred embodiment of the invention, however, the registered form of payment data consists of financial data, including the name of the card owner, a registered form of payment number, and an expiry date. In a particular embodiment of the present invention, the member area (26) lists a number of different registered forms of payment and enables members to select one or more registered forms of payment and provide the associated data.

The registered form of payment data is stored to the database (16) based on processes defined by the database management utility (22). In one particular implementation of the invention, registered form of payment data is encrypted and stored to the database (16) in an encrypted form to maintain the security thereof. Alternatively, the registered form of payment data is stored to the database (16) such that retrieval of the registered form of payment data from the database (16) is restricted.

Once the requisite sign-up data has been provided by the member, the member is registered to the server computer (12), and by operation of the administration utility (24) the registered member is provided access to the functions of the server application (14) accessible to members and described below.

In another aspect of the present invention, the server application (14) is adapted to authenticate members so as to verify the identity of a member logging on to the web site (18). In one particular implementation of the present invention, upon completion of the sign-in process described above, the administration utility (24) defines a unique identifier for the member by operation of a random number generator, in a manner that is known. In the same particular implementation of the present invention, the unique identifier consists of a passphrase or equivalent which is communicated to the member by means of an e-mail created and sent by operation of the communication utility (20). Thereafter, the member uses the passphrase to login to the web site (18), which is passed to the administration utility (24) in order for the participant to obtain access to the functions of the server application (14) described below.

One or more partners also sign up with the operator of the server computer (12). The partners consist of businesses who are interested in obtaining access to the loyalty solution provided by the operator of the server computer (12). The web site (18) also includes the partner area (28) that provides access to functions (including administrative functions) described below. Partners also sign-up through the administration utility (24) by providing requisite identification data, and by obtaining authentication data, in accordance with processes similar to the sign-up procedures for members identified above. The sign-up of partners with the administration utility (24) enables access by partners to access member transaction data linked to the particular partner, as described below.

In another aspect of the present invention, the operator of the server computer (12) obtains identification data for the partners from the operator of the registered form of payments. In one particular implementation of the present invention, partners provide their financial authorization to facilitate data collection. This generally consists of an alphanumeric code that identifies the particular partner or member.

In an aspect of a particular implementation of the present invention, the operator of the server computer (12) obtains consent from the partner and the member to enter into an arrangement with the one or more registered form of payment providers selected by the participant, as described above. The operator of the server computer (12) creates a data link with the holder of registered form of payment data for each member.

For example, the operator of the server computer (12) contracts with an entity processing registered form of payment transactions or transaction processor (32), and provides parameters for filtering the registered form of payment transaction data for the member to obtain financial transaction data of interest, namely registered form of payment transactions of the member associated with one or more partners who have registered with the operator of the web site (18). The filtering generally occurs by means of a database query made by the transaction processor (32) based on a data set that includes the registered form of payment number of the member and the partner authorization number of a particular partner.

The transaction processor (32) provides financial data (34) to the operator of the server computer (12), which at least includes: an identifier for the member, an identifier of the partner from which a purchase was made, the settlement date and the amount that the member spent with the partner. The transfer of the financial data (34) occurs through a secure manner, for example, using secure transmissions such as Secure Sockets Layer (SSL) or encryption/decryption using a known method such as PKI.

As a measure for improving security, the parameters provided by the operator of the server computer (12) to the transaction processor (32) include a unique data tag (36) defined by the operator of the server computer that is not the same as the member's registered form of payment data. The financial data (34) includes the data tag (36) and not the registered form of payment data such as the member's credit card information.

The server application (14) also includes a loyalty engine (38). The loyalty engine (38) is best understood as an aspect of the database management utility (22), configured to execute the loyalty operations described in the invention. The loyalty engine (38) is linked to the database (16). The loyalty engine (38) creates on the database (16) a loyalty account (40) for each member, which is used to record the then current loyalty records and chances to win prizes accumulated by the member by operation of the present invention. There is generally one loyalty account (40) per member, per partner registered to the web site (18).

Upon receipt of financial data (34) at the communication utility (20), the loyalty engine (38) is operable to process the financial data (34) and credit the appropriate loyalty account (40). Another aspect of the loyalty engine (38) is that it applies for each member/partner the then applicable loyalty rules (42) for calculating the loyalty benefit or partner rewards\ that is available to each member, based on the transaction and the status of their loyalty account (40).

The loyalty engine (38) includes a reward administration utility (44). This is a utility that is accessible to partners via the partner area (28). It allows the partners to define and dynamically update the parameters for rewards and redemption of rewards for the loyalty accounts (40) for members associated with the particular partners. The reward administration utility (44) provides a series of interfaces for defining:
Administers activities required by members to obtain loyalty rewards and chances to win prizes.
Administers quantum of loyalty rewards, Cross-Promotional Partner Rewards and chances to win prizes assigned to particular activities. The Cross-Promotional Partner Reward feature allows a partner to combine rewards from other partners, with their existing rewards, that enhances the overall reward to members (e.g. a rental car company may include a reward golf round combined with their own reward offer for a rental car).
Prizes available (prizes also include discounts on goods and services offered by partners).
How the administration and awards for particular prizes will be accomplished.

Partners are permitted to adjust the values associated with any particular loyalty program and/or reward for future reward periods. A reward period is the validity period set by the server application (14) for the reward offer. Partners also provide members with the ability to reserve a partner defined reward on line for later redemption through the use of an assigned member reward number. A member reward number is a unique identifier related to a specific reward and a specific member. This combined with the reporting functions of the present invention described above enable the partners to customize loyalty benefits that maximize their revenue and/or profitability (or achieve other objectives).

Partners and sponsors determine prizes that are contributed to allRewards™. The administration of the contributed prizes is controlled throught the super admin area (66) by the operator of the server application (14). In a particular embodiment of the invention, partners and sponsors regularly contribute prizes to be awarded to members through the prizing utility (64).

Another aspect of the present invention is that the reward administration utility (44) includes or provides access to a series of reward program templates that assists the partner in designing a reward program. Another aspect of the reward administration utility (44) is that it provides access to text, graphics, and other electronic media to assist in the design of an effective reward program. In one particular implementation of the present invention, web pages are displayed in the partner area (28) that are used to obtain input from the partner required to design/implement a particular reward program or product/service reward including cross-promotional partner rewards, and that also contain general information on designing effective reward programs.

Yet another aspect of the present invention is that partners report on the effectiveness of reward programs and rewards operated by means of the present invention, and the reward administration utility (44) uses the database to assist in structuring rewards for specific members and recommends alterations to the reward program to partners that are likely to achieve improvement of results.

Members that log in to the member area (26) are provided access to one or more web pages linked to their loyalty account(s) (40). The information displayed on these web pages are updated in a manner that is known by operation of the server application (14). Members who have logged in to the member area (26) are also provided access to some aspects of the loyalty engine (38) for the purpose of assessing the winners of prizes and to obtain any additional rewards by partners.

In a particular implementation of the present invention, the loyalty engine (38) creates a unique member reward number for a particular partner upon receipt of a request from the member to make an authorized redemption. The member reward number identifies the partner's specific reward and identifies the member. The member takes the member reward number to the partner and presents the same for the applicable reward or discount offer at business premises of the partner. In a particular aspect of the present invention, the member reward number may be accessed on the internet, through electronic notification or obtained by the member at the partner's site by accessing the web site through wireless or direct connection communications.

It is preferable for the partner to report to the operator of the server computer (12) when a particular member reward has been redeemed. This data is then accessed by the reporting utility (46) to assess the effectiveness of the member reward, as explained below. When no information is reported, the operator of the server computer (12) can match member reward numbers with transactions and dates to link partner rewards with member financial transactions at the partner's site.

Another aspect of the present invention is that the financial registered form of payment activity at a participating partners' site provides opportunity for members to win prizes through the prizing utility (64) following filling out one or more portions of the survey form (50) regarding the partner and the product/service reward or discount. A survey may be required by the operator of the server computer (12):
Upon sign-up.
Prior to the award of any prizes.

The surveys can be designed to obtain feedback from members on a number of different matters. A member can receive Local, Regional and National and prize opportunities by completing all portions of the survey, in one particular embodiment of the invention.

The loyalty engine (38) includes a survey design utility. The survey design utility (48) includes a series of survey templates as well as instructions for designing an effective survey (50). The parameters of each survey created by a partner or the server application (14) are stored to the database (16). The server application (14) is adapted to publish the various surveys (50) as a web page accessible to the members via the member area (26).

The surveys (50) generally consist of a plurality fields that are completed by members. The data from the various completed surveys is then stored to the database (16) in a manner that is known. The data included by members into the various surveys (50) associated with a particular partner is available to that partner. This data can be utilized for a number of business purposes, including service improvements. One aspect of the surveys (50) is to solicit feedback on the effectiveness of the loyalty program overall. This data can be used by partners to adjust their loyalty programs and rewards and cross-promotional partner rewards by operation of the loyalty engine (38), in response to the feedback provided by the survey. The survey system (50) rates rewards and the transaction experience based upon direct member feedback.

Partners will generally associate the opportunity to win a prize through the prize utility (64) with the completion of a survey (50).

One of the advantages of the present invention is that it provides partners ready access to the data included in the surveys (50). It has generally been found to be difficult to have members fill out surveys, and therefore the response ratios have been quite low. Providing the survey on-line, in combination with a loyalty program familiar to the member, and particularly as part of an activity that will result in or is associated with winning a prize, has been found to improve this ratio significantly.

It should be understood that the present invention enables partners to receive information regarding the activities of members in real time or in batch format. By operation of the reporting utility (46) in co-operation with the communication utility (20), for example, escalation procedures can be established such that if a member fills out a survey (50) indicating that s/he was “NOT SATISFIED” with a particular product or services, an alert can be communicated to the partner. The loyalty engine tracks purchasing habits (with alerts) for selected members.

The reporting utility (46) enables a plurality of reporting functions based on the financial data (34), activities of members in relation to their loyalty account (40), and survey data, including:
A mapping system (52) that tells (and displays in a map) to the partner where members making purchases originate from.
An incentive tracking system (54) that allows the partner to track rewards and cross-promotional partner rewards that have been redeemed, including at particular partner sites.
The reward tracking system (54) also allows the partner to track how much revenue the allRewards™ system has generated from rewards and cross-promotional partner rewards. The reporting utility (46) cooperates with the reward tracking system (54) such that the incremental revenue can be recorded in a partner reward redemption file. At any point, the partner can determine the incremental revenue by individual or all rewards, by operation of the reporting utility (46).

It should be understood that a number of other related functions can be added to the reporting utility (46) in a manner that is known.

The functions of the reporting utility (46) enable the partners to assess the effectiveness of specific loyalty reward programs and to make adjustments on an ongoing basis by operation of the reward administration utility (44).

In another aspect of the present invention, the server application (14) supports relationships between particular members, partners and sponsors. Sponsors may be suppliers of products sold by partners and may provide, for example, certain goods or services for promotional purposes and prizes. The server application (14) also defines a sponsor area (56) on the web site (18) which enables sponsors to review:
Data regarding sponsor's goods/services that have been awarded or distributed.
Particulars of such awards and distributions (including, for example, prizes).
Data regarding particular members who have acquired prizes awards of the sponsor.

The advantage for sponsors is that it enables the distribution of goods/services into target markets of interest at a relatively small cost. For example, in the case of a partner that is a golf course, the cross-promotional partner might be an athletic clothing manufacturer (e.g. of golf shirts).

This merely illustrates some of the cross-promotional partner reward benefits of the present invention. The present invention acts as a platform for a plurality of partners for testing cross-promotional activities, obtaining feedback real time on how members rate rewards and their effectiveness, and making adjustments to cross-promotional elements of a particular loyalty program over time. This provides better coverage to partners, and also more targeted marketing to selected market groups. The present invention acts as a platform for a plurality of partners to use cross-promotional partner reward activities for increased cost effectiveness. Partners receive feedback when members evaluate and rate rewards, providing real time feedback on reward effectiveness as well as the performance of the partner's recent service.

Participating partners directly create cross-promotional rewards among other participating partners, negotiate these directly with other participating partners and offer the promotions to members through the loyalty engine. The system provides better coverage to partners than partners get from other methods and allows targeted marketing to selected market groups. The system also provides direct tracking of incremental spending by partner location and identifies to the partner where the member comes from.

FIGS. 1 and 2 illustrate a plurality of processes enabled by operation of the loyalty engine (38) for the creation of loyalty programs, in accordance with one particular aspect of the present invention.

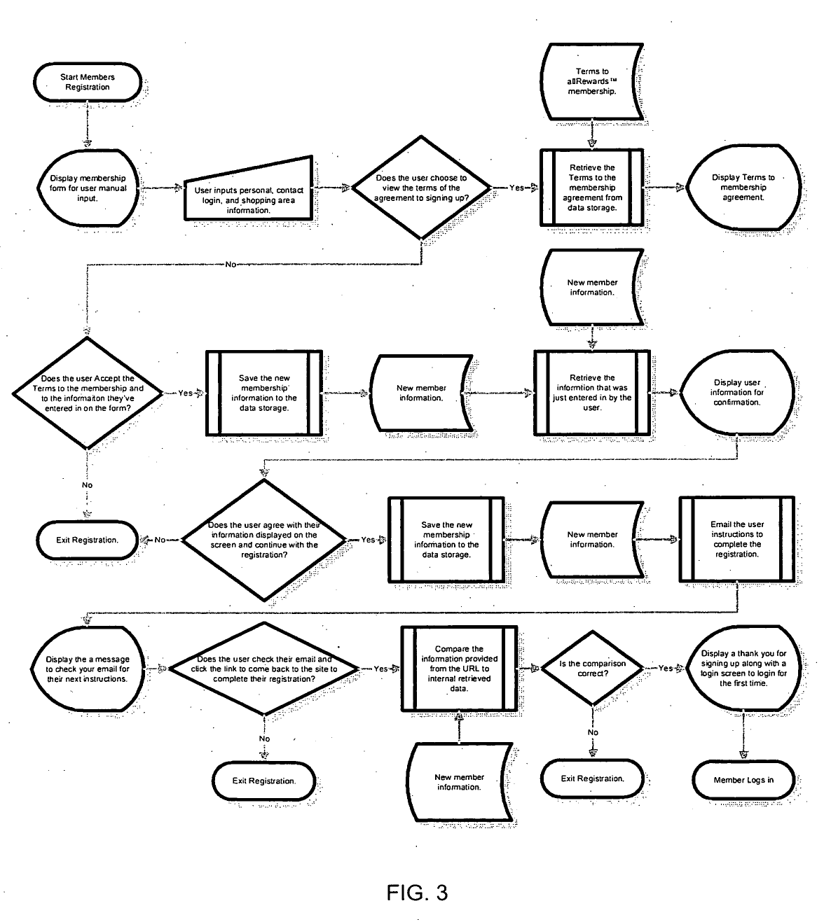

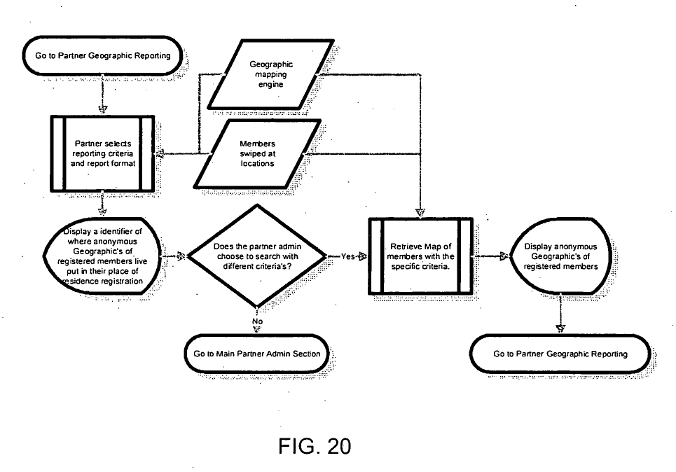

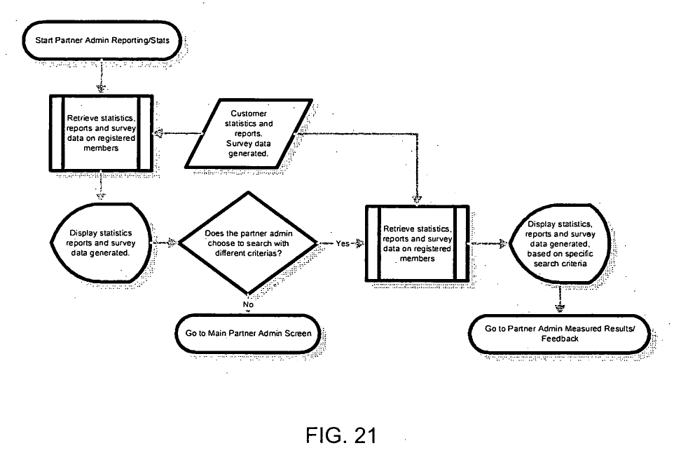

FIGS. 3-21 illustrate in more detail particular aspects of the present invention.

FIG. 1 is a flowchart that illustrates the physical aspects and components of the overall invention.

FIG. 2 is a flowchart that illustrates the software system aspects and compliments of the overall invention.

FIG. 3 is a flowchart illustrating the registration process for participants to become members and certain processes related to the registration of participants to the web site (18).

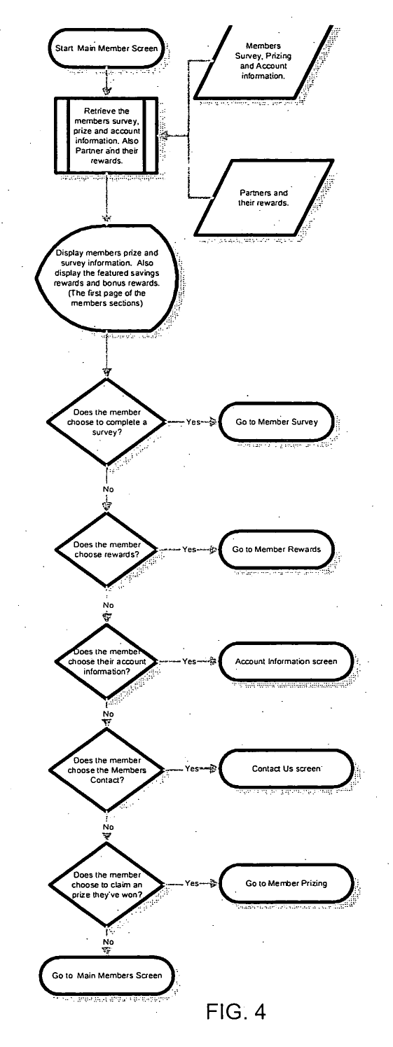

FIG. 4 is a flowchart illustrating the log in and member area (26) options including (e.g. partner reward options, cross-promotional partner reward options, completing surveys, details for prizing opportunities, contact the operator of the server application (14), update of personal information and registered forms of payment).

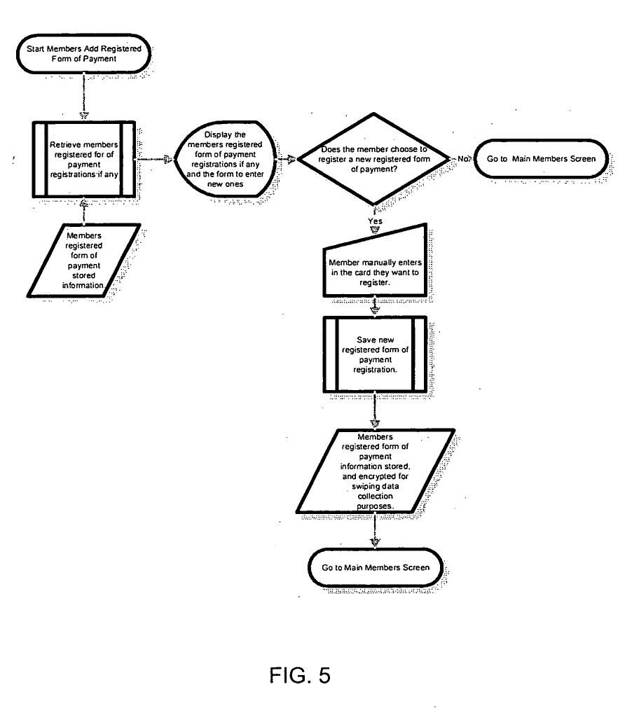

FIG. 5 illustrates further processes involved in a particular embodiment of the member area (26) which allows the inclusion of registered forms of payment. In this particular function, the member securely registers one or more financial cards or other forms of payment for identification when the card is used at participating partner sites. Financial information is encrypted and stored in the server application (14), for use in the loyalty engine (38).

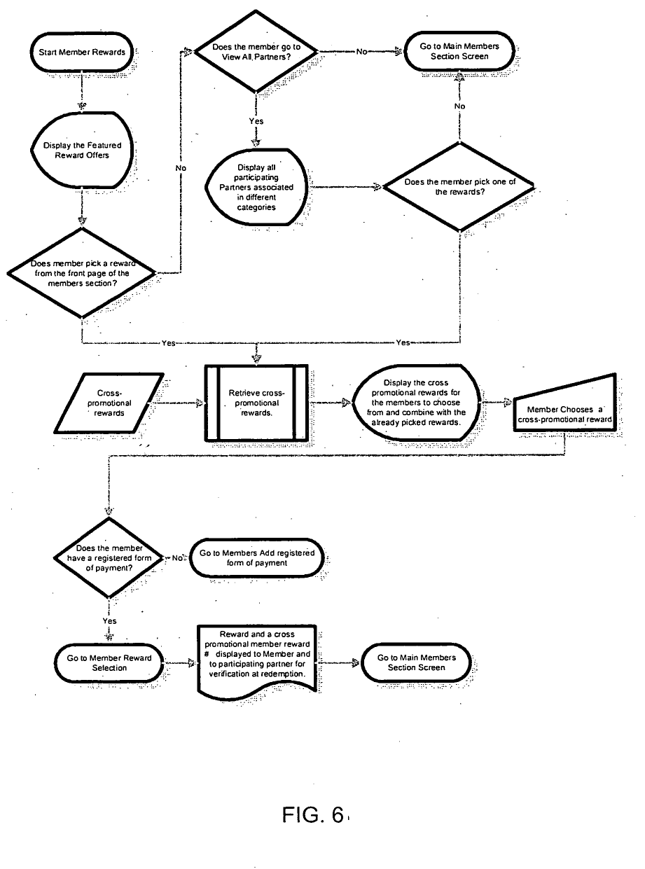

FIG. 6 illustrates the processes involved in a particular embodiment of the member area (26). In this embodiment of the present invention, the server application (14) includes a member reward number utility (58). The member reward number utility (58) is a known utility for making reservations by a series of web interfaces. This is a useful resource where the partner sells goods or services that are reserved for the member through the member reward number. A member can review partner rewards and cross-promotional partner rewards through the server application (14). The member then selects a desired reward and cross-promotional partner reward and is supplied a member reward number by the member reward number utility (58) to present at the partners' site for redemption. If the member fails to select a cross-promotional partner reward the system automatically selects a cross-promotional reward.

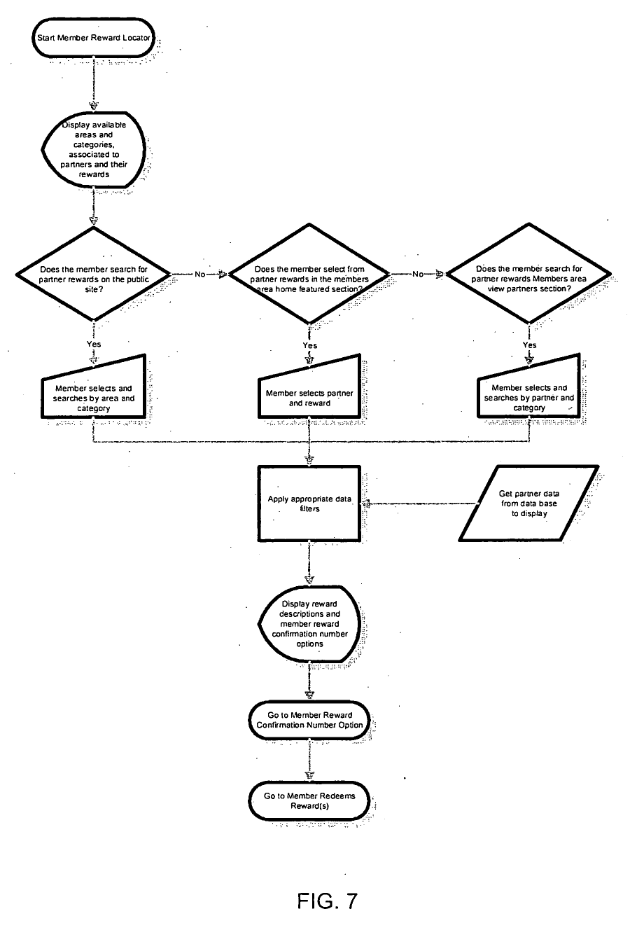

FIG. 7 illustrates a particular embodiment in which a member obtains reward opportunities outside their selected Shopping Area. A Shopping Area is a defined geographic area of commercial activity (e.g City of Edmonton) as defined by the server application operator (14). Each member has a defined Shopping Area, typically the geographic area in which they reside. The member can log on and choose a different Shopping Area and review reward opportunities and receive member reward numbers for the newly selected Shopping Area. This allows a traveling member to access and redeem reward opportunities in different cities across the country.

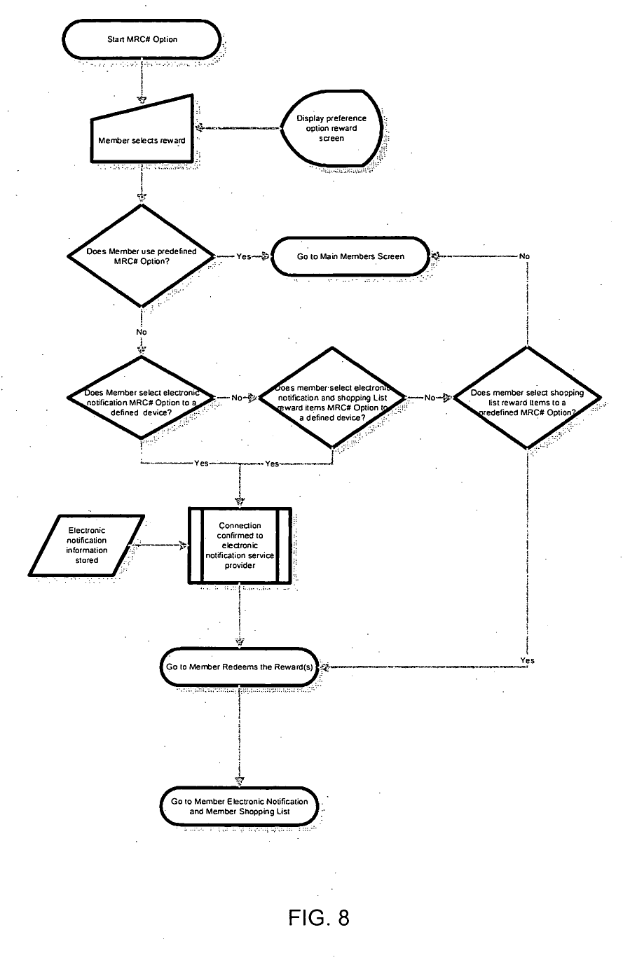

FIG. 8 illustrates the particular embodiment of a member defining a method of retaining a member reward confirmation number until a reward is redeemed at a participating partners' site. The member reward number utility (58) is connected to the communication facility (20) from which the member can choose a predefined option, electronic notification, and/or a shopping list. A predefined option is one where a member chooses a specific method to record and retain a member reward number.

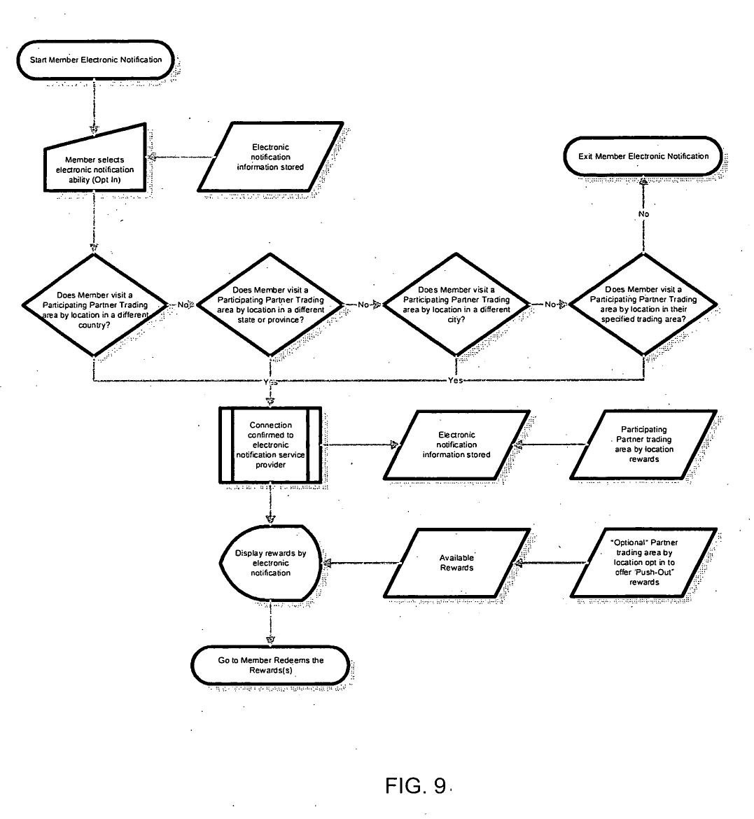

FIG. 9 illustrates a particular embodiment in which the member receives, as an electronic notification, a member reward number through the member reward number utility (58). In a particular embodiment of this electronic notification a member reward number is sent via e-mail, text message or other electronic means to a selected address or number designation, as defined by the member for future use at a participating partners' site.

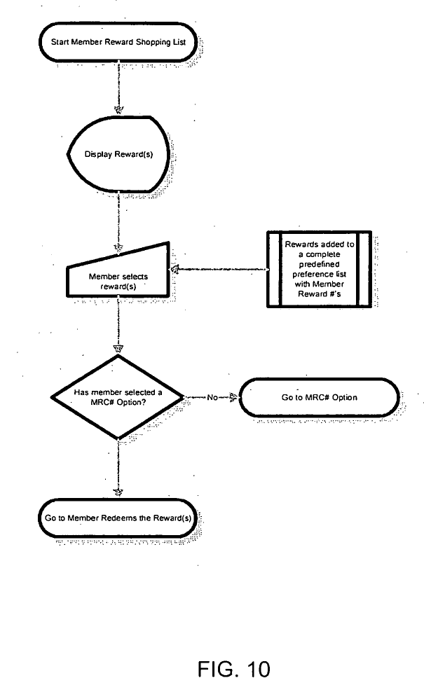

FIG. 10 illustrates the particular embodiment of the member receiving multiple member reward numbers through a shopping list. A shopping list consists of multiple member reward numbers selected by the member for future redemption. The defined member reward numbers can be compiled into a single list and forwarded by electronic means as described in FIG. 9 or by the predefined form of notification.

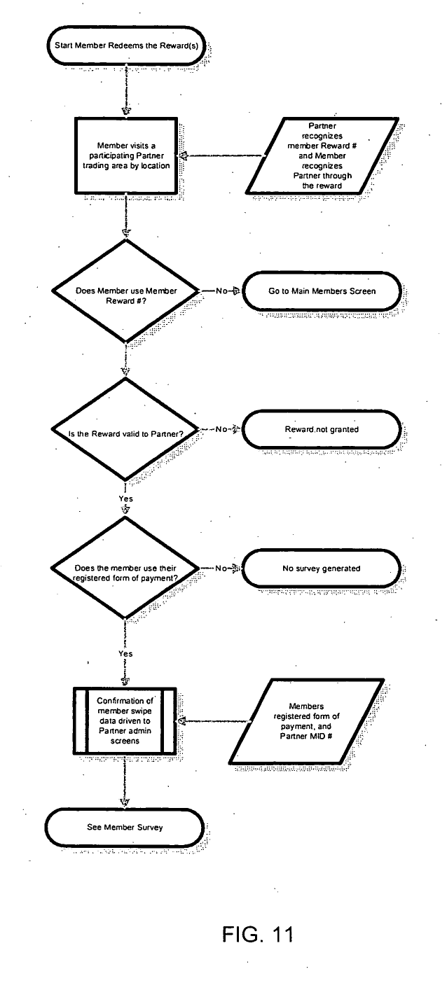

FIG. 11 illustrates a particular embodiment in which the member redeems the reward at the participating partners' site. The member goes to the participating partners site and presents the member reward number to redeem the reward offer. The partner verifies the member reward number and reward terms. When the member uses a registered form of payment to pay for products or services, the member reward number and the purchase are matched by the loyalty engine and communicated to the partner through the reward administration utility (44). This is particularly advantageous as it then enables the partners to be notified regarding allRewards™ member transactions.

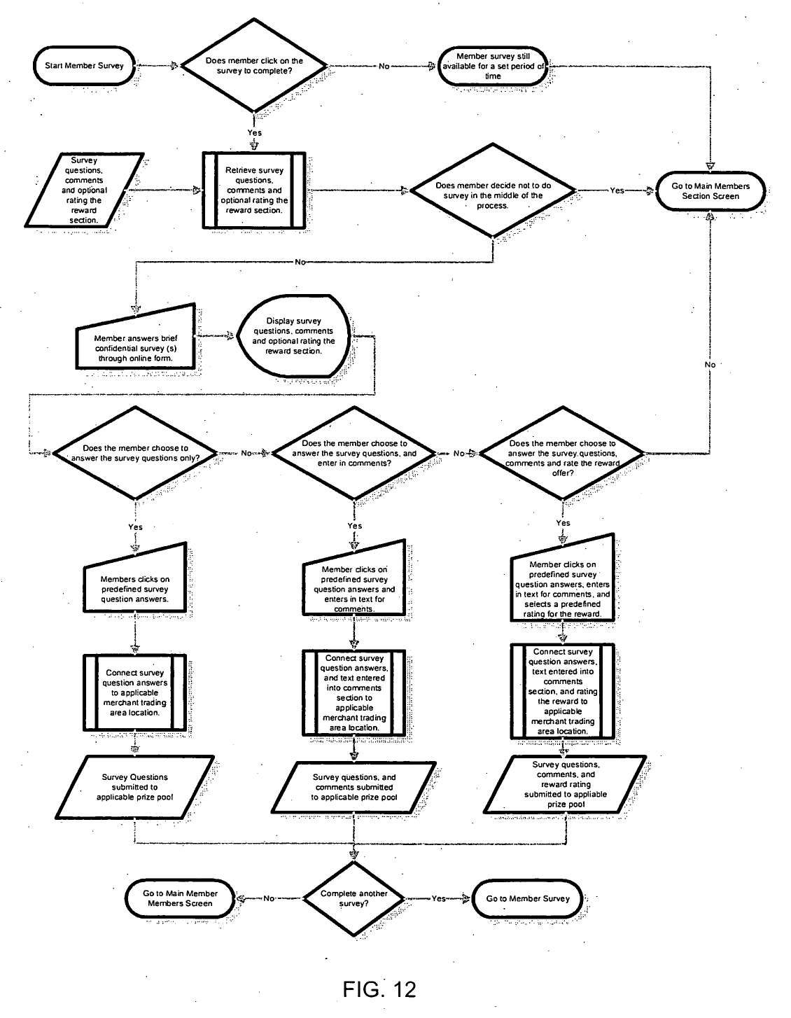

FIG. 12 illustrates the operation of the loyalty engine (38) in relation to surveys (50) for completion by members for prizing opportunities through the prizing utility (64), in one particular embodiment thereof. Following receipt of the registered form of payment financial data (34) by the server application (14), the member may operate the survey function (60) to qualify for prizing. Surveys can include multiple levels of detail and members can earn prize opportunities by completing one or more levels within the survey. Surveys (50) are collected and reported to the partner through the reporting utility (46).

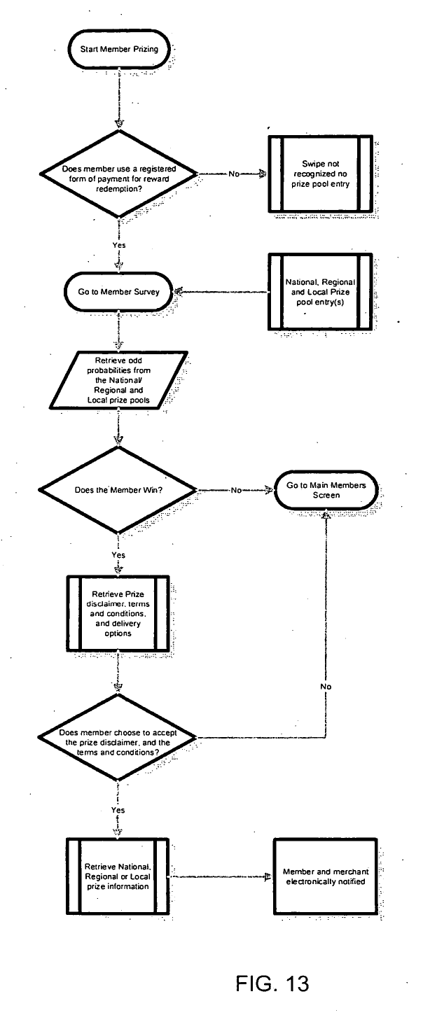

FIG. 13 illustrates the administration of prizing through the prizing utility (64), in accordance with a particular aspect of the invention. whereby in a particular application of the prizing administration (Local, Regional, and National prizes are awarded periodically). In one particular embodiment thereof a member, by completing specific portions of a survey form (see FIG. 12) receives a chance to win prizing opportunities in Local, Regional or National Prize Pools. The prizing utility (64) administers the prizing awards and distribution.

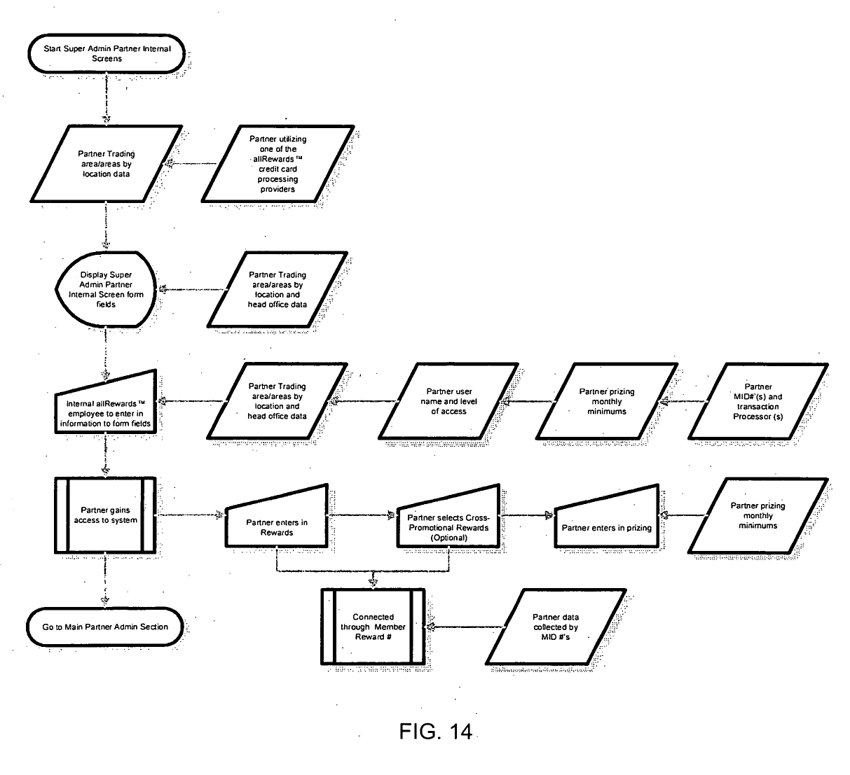

FIG. 14 provides an overview of the plurality of functions administered by the server application (14) for the super admin area (66). The super admin area is a function operated by the server application (14) whereby functions including but not limited to adding and/or modifying; partner security and access; sponsor security and access; news and updates; and prizing administration in the server application (14). The super admin area (66) orginates partner site identification numbers by Trading Areas; assigns and administers member reward numbers and links financial card processing provider status to partner sites' through the server application (14). Trading areas are defined for each participating partner sites' and service offering. More then one Trading Area may exist within a Shopping Area. Minimum prizing contributions by each partner and sponsor are viewed and administered through the super admin area (66).

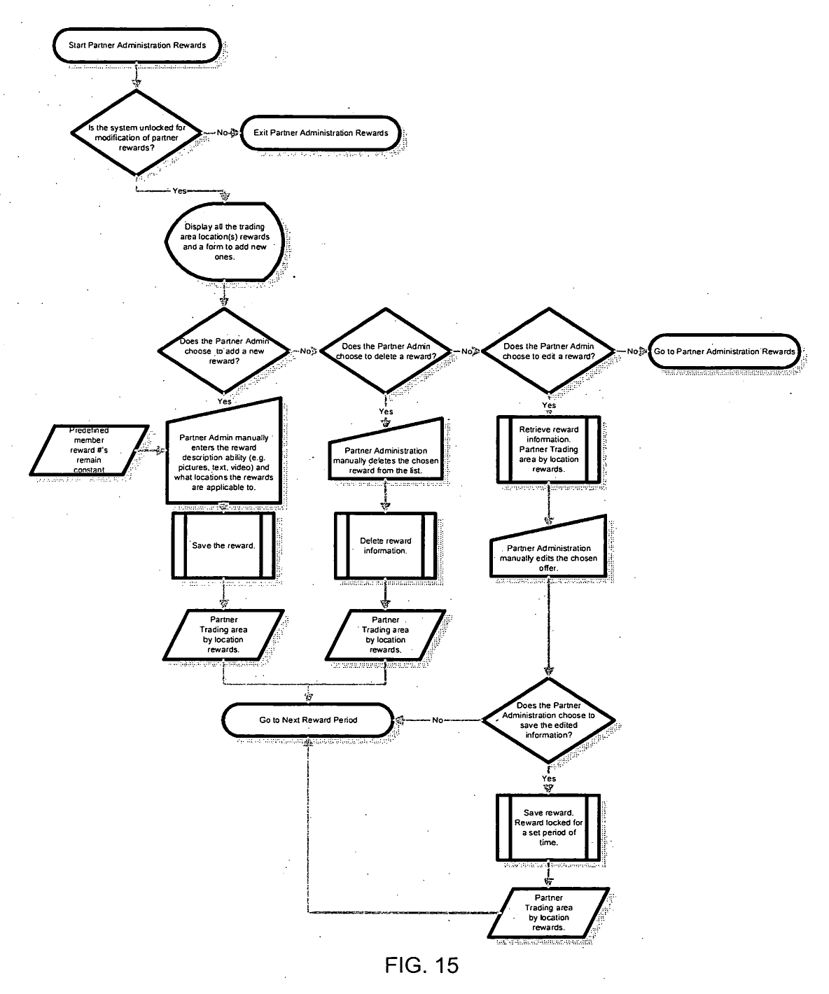

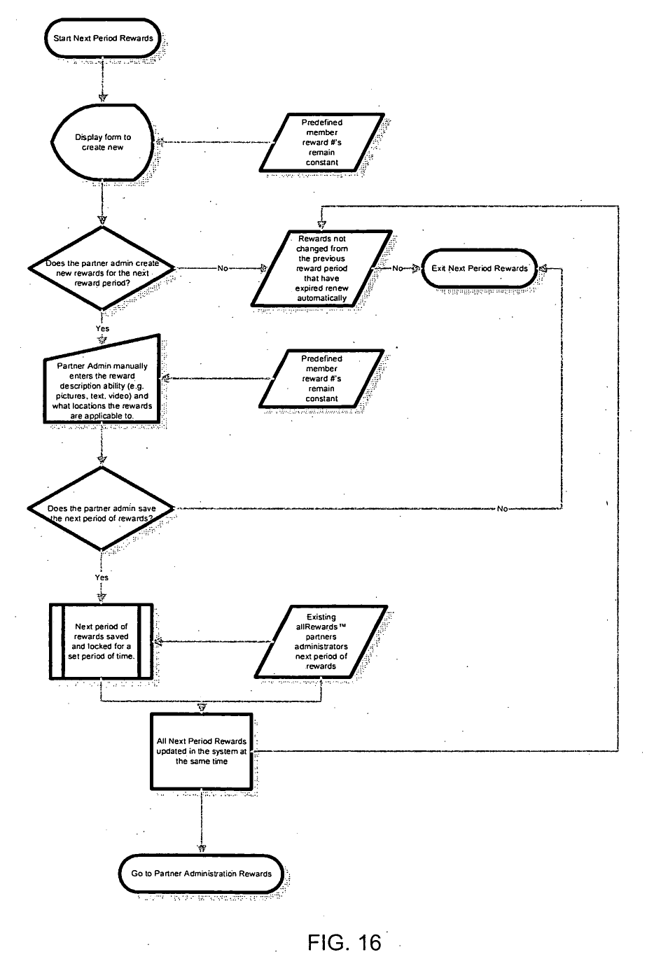

FIG. 15 details one embodiment of the partner area (28) in operation of the reward admin utility (44). In one particular embodiment thereof partners determine the reward description for member redemption. The server application (14) limits modification of reward offers during their defined reward period. A partner may modify reward descriptions for a future reward period (see FIG. 16). The server application (14) controls the number of reward offers available per partner at any given time. Rewards are maintained through their entire validity period. Partners may plan for future reward offers that are applied when current reward offers have expired (See FIG. 16).

FIG. 16 details another embodiment of the partner area (28) in operation of the rewards admin utility (44) for next period rewards. A partner can modify reward descriptions for a future reward period. The server application (14) controls the number of reward offers available per partner at any given time.

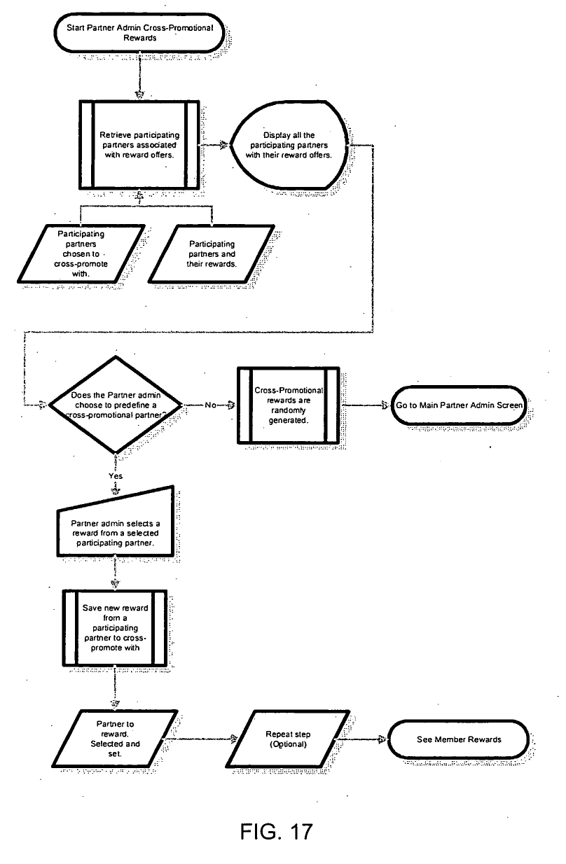

FIG. 17 details still another embodiment of the partner area (28) in operation of the rewards admin utility (44) for cross-promotional partner rewards. Participating partners can work together to commonly group rewards for a more attractive presentation to the member. Partners who are not participating in on-line cross-promotional agreements are still provided an opportunity to have their particular rewards displayed through a system generated cross-promotional reward viewed by the member.

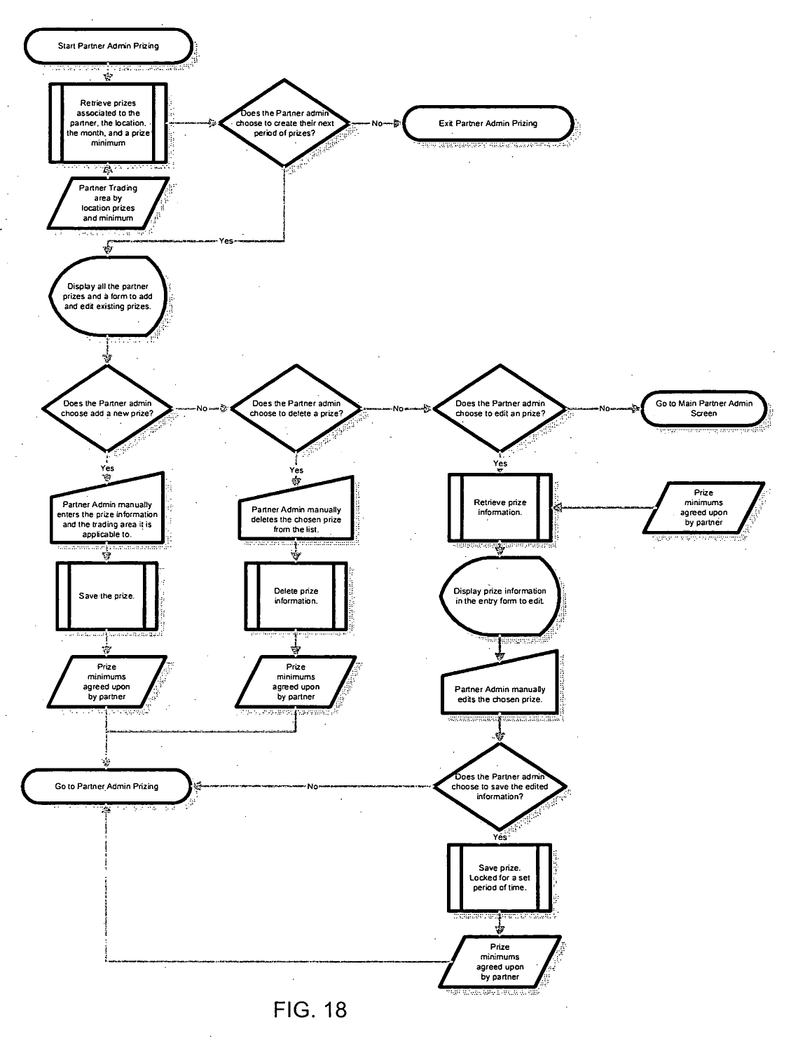

FIG. 18 illustrates a particular embodiment in which partners can receive reports on the geographic location of participating members redeeming rewards at the partners' site. Members use their registered credit to identity their postal code/zip code identification. The system compiles member locations in a geographic visual figure.

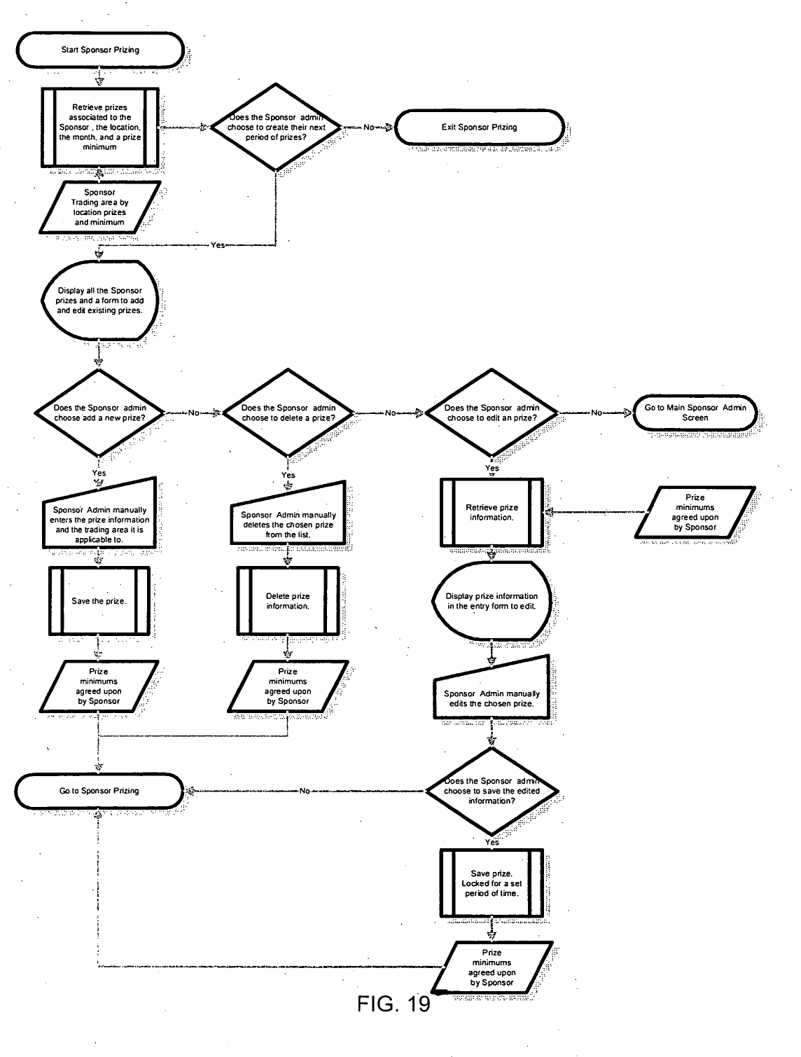

FIG. 19 illustrates a particular embodiment in which partners can receive reports on measured results and customer feedback provided through the members' surveys. Partners are notified real time of significant member feedback, provided from the members' survey. Partners also receive reports developed from member participation data including but not limited to incremental revenues generated, members visits, and cross-related to member demographics and geographic location.

Other extensions of the present invention are possible. Additional features can be added to the server application, and its various utilities described in this disclosure, without departing from the invention.

What is claimed is:

1. A method of encouraging customer loyalty, comprising the steps of:
(a) One or more partners defining a loyalty program, the loyalty program defining loyalty rewards associated with one or more activities;
(b) Registering one or more members with the loyalty program, whereby their registration includes the provision of registered form of payment data for one or more registered form of payment types of each of the one or more members;
(c) Collecting financial data corresponding to transactions of the one or more members associated with the one or more partners, and providing said financial data to a loyalty engine; and
(d) Providing access to the loyalty engine to the one or more partners, the loyalty engine permitting the one or more partners:
(i) To define the rules impacting the loyalty program, including partner rewards and cross-promotional partner rewards to members and the application of the loyalty engine to provide benefit including prize opportunities.
(ii) Monitoring the effectiveness of the loyalty program; and
(iii) Modifying the loyalty program to enhance its effectiveness.

2. A method of encouraging customer loyalty as claimed in claim 1, the loyalty engine enabling at least two partners to define one or more cross-promotional loyalty programs and the eligibility rules for such cross-promotional loyalty programs, whereby such cross-promotional loyalty programs define a trading area within a web site provided to the one or more members.

3. A method of encouraging customer loyalty as claimed in claim 2, whereby in response to one or more members registering within one of the cross-promotional loyalty programs, the one or more members are provided with a shopping list of reward numbers each corresponding with one of the partners participating in a particular cross-promotional loyalty program.

4. A method of encouraging customer loyalty as claimed in claim 3, comprising the further step of the loyalty engine defining a shopping area, the shopping area providing the benefits available to members via the loyalty engine in a geographic area associated with a member.

5. The method of claim 1, comprising the further step of requiring the one or more members to fill out a survey regarding the one or more partners.

6. The method of claim 5, comprising the further step of the one or more partners defining the contents of the survey.

7. The method of claim 6, comprising the further step of linking loyalty rewards and/or prize opportunities to completion of the survey.

8. The method of claim 1, comprising the further steps of:
(a) Defining a unique identifier for each participating member;
(b) Unique identifier confirmation number for each loyalty reward redemption.
(c) Providing the unique identifier and partner authorization data for the one or more members to a transaction processing entity for the one or more registered form of payments; and
(d) Filtering registered form of payment transactions processed by the transaction processing entity for each participant to select the registered form of payment transactions associated with the one or more members;
(e) Providing data corresponding to the selected registered form of payment transactions to the operator of the loyalty engine.

9. The method of claim 8, whereby the data corresponding to the selected registered form of payment transactions includes one or more of the following:
(a) The member's unique identifier;
(b) Unique identifier confirmation number for each loyalty reward redemption.
(c) Identification data for the partner; and
(d) Settlement date and the amount the member spent with the partner.

10. The method of claim 9, comprising the further step of providing reports to the one or more partners reporting on the effectiveness of the loyalty program, the reports assisting in the modification of the loyalty program to improve the effectiveness thereof.

11. A system for encouraging customer loyalty, the system being operable to connect to one or more remote computers to provide access to the resources of the system at said one or more remote computers, the system comprising:
(a) A server computer;
(b) A server application linked to the server computer, the server application including a loyalty engine, the server application being operable to provide instructions to the server computer that:
(i) Enable one or more partners to define rules for a loyalty program, the loyalty program including loyalty rewards and/or prize opportunities associated with one or more activities;
(ii) Register one or more members with the loyalty program, wherein the registration includes the provision of registered form of payment data for one or more registered form of payment types of each of the one or more members; and
(iii) Collect financial data corresponding to transactions of the one or more members associated with the one or more partners, and providing said financial data to a loyalty engine; and
Wherein the loyalty engine is operable on the server computer to enable the partners to:
(i) To modify the rules for the loyalty program on a dynamic basis, including rules for accumulation of loyalty rewards and/or prize opportunities, and redemption of loyalty rewards;
(ii) Monitoring the effectiveness of the loyalty program; and
(iii) Modifying the loyalty program to enhance its effectiveness.

12. The system claimed in claim 11, wherein the server application is operable to collect survey data from members.

13. The system claimed in claim 12, wherein the server application is operable to link loyalty rewards and prize opportunities to provision of survey data, by operation of the loyalty engine.

14. The system claimed in claim 12, wherein the server application is operable to:
(a) Establish a unique identifier for each member;
(b) Unique identifier confirmation number for each loyalty reward redemption.
(c) Provide the unique identifier and partner authorization data for the one or more partners to a remote transaction processing system associated with the one or more registered form of payments;
(d) Receiving selected registered form of payment transaction data from the remote transaction processing system corresponding to the registered form of payment transactions associated with the one or more partners for the member; and
(e) Applying the selected registered form of payment transaction data to the loyalty engine, thereby applying the rules for the applicable loyalty program to the selected registered form of payment transaction data.

15. The system claimed in claim 14, wherein the selected registered form of payment transaction data includes:
(a) The unique member identifier;
(b) Identification data for the partner; and
(c) Unique identifier confirmation number for each loyalty reward redemption.
(d) Settlement date and the amount the member spent with the partner.

16. The system as claimed in claim 12, wherein the server computer is linked to a database and the server application includes a database management utility for managing the storage and retrieval of data from the database related to the operation of the loyalty engine, wherein the database management utility is operable to encrypt to the database personal information provided by the members.

17. The system as claimed in claim 12, wherein the server application includes an administration facility that enables hierarchical access to partners or members to functions of the server application or data stored to the database, based on permissions defined by the operator of the server computer.

18. The system as claimed in claim 12, wherein the server application is operable to publish a series of web pages to the Internet, wherein the web pages include:
(a) One or more web pages defining a member area that provides access to functions of the server application dedicated to members; and
(b) One or more web pages defining a member area that provides access to functions of the server application dedicated to partners.
(c) One or more web pages defining a member area that provides access to functions of the server application dedicated to sponsors.

19. The system as claimed in claim 18, wherein the server application includes a reward administration utility that enables partners to modify the rules for one or more of their loyalty programs, wherein the reward administration utility is operable to enable members to perform one or more of the following functions:
(a) Definition of the activities required to acquire loyalty rewards and/or prize opportunities;
(b) Definition of the quantum of loyalty rewards and/or prize opportunities assigned to particular activities; and
(c) Administration of prize awards and prize redemption by a partner.

20. The system as claimed in claim 12, wherein the server application includes a reporting utility, wherein the reporting utility is operable to analyze data stored to the database associated with participant accumulation of prize opportunities to populate one or more reports, and present the reports to the associated partner, the reports assisting the partner in modifying the rules for one or more of their loyalty programs to improve their effectiveness.

21. The system claimed in claim 18, wherein the partner area enables members to:
(a) access a loyalty account that reflects a substantially real time loyalty rewards and prize opportunities; and
(b) Redeem loyalty rewards through a member reward number.

22. A computer program product, for use on a server computer, the computer program product comprising:
(a) A computer usable medium;
(b) Computer readable program code recorded or storable in the computer useable medium, the computer readable program code defining a server application on the server computer that is operable on the server computer to:
(i) Enable one or more partners to define rules for a loyalty program, the loyalty program including loyalty rewards and prize opportunities associated with one or more activities;
(ii) Register one or more members with the loyalty program, wherein the registration includes the provision of registered form of payment data for one or more registered form of payment types of each of the one or more member;
(iii) Enable member to acquire rewards using a unique member reward number to redeem reward at partners' site.
(iv) Collect financial data corresponding to transactions of the one or more members associated with the one or more partners, and providing said financial data to a loyalty engine; and
Wherein the loyalty engine is operable on the server computer to enable the partners to:
(v) To modify the rules for the loyalty program on a dynamic basis, including rules for loyalty rewards, and redemption of the loyalty rewards;
(vi) Monitoring the effectiveness of the loyalty program; and
(vii) Modifying the loyalty program to enhance its effectiveness.

23. A computer program product as claimed in claim 22, wherein the loyalty engine includes a reward administration utility that enables partners to modify the rules for one or more of their loyalty programs, wherein the reward administration utility is operable to enable partners to perform one or more of the following functions:
(a) Definition of the activities required to acquire loyalty reward and/or prize opportunities;
(b) Definition of the loyalty rewards assigned to particular activities; and
(c) Prizes available.
